(19) United States
(12) Patent Application Publication
(10) Pub. No.: US 2015/0268186 A1
(43) Pub. Date: Sep. 24, 2015

(54) SYSTEMS AND METHODS FOR DIAGNOSTIC TESTING

(71) Applicant: ApolloDX, LLC, Salt Lake City, UT (US)

(72) Inventor: William Robert Pagels, Salt Lake City, UT (US)

(21) Appl. No.: 14/621,260

(22) Filed: Feb. 12, 2015

Related U.S. Application Data
(63) Continuation of application No. PCT/US2014/054393, filed on Sep. 5, 2014.
(60) Provisional application No. 61/881,901, filed on Sep. 24, 2013.

(51) Int. Cl. G01N 27/327

(52) U.S. Cl. CPC G01N 27/327

(57) ABSTRACT

Described are devices, systems, and methods for performing diagnostic tests. The diagnostic systems are capable of performing analytic tests and communicating with a portable multifunctional device (PMD) or other computing device. Systems include an analyzer configured to transmit electrical signals between the computing device and a sample cartridge. Through communication with the sample cartridge via the analyzer, various tests may be performed and controlled by the computing device. These analytic tests may include, but are not limited to, sensing or quantification of chemicals from a sample input, whether gaseous, liquid, or otherwise, sensing or quantification of analytes, antibodies, or antigens, sensing or quantification of genetic material, or other substances.

### CROSS-REFERENCE TO RELATED APPLICATIONS

This application is a continuation of International Patent Application PCT/US2014/054393, filed Sep. 5, 2014, designating the United States of America and published in English as International Patent Publication ______ on ______, which claims the benefit under Article 8 of the Patent Cooperation Treaty and under 35 U.S.C. §119(e) to U.S. Provisional Patent Application Ser. No. 61/881,901, filed Sep. 24, 2013, the disclosure of each of which is hereby incorporated herein in its entirety by this reference.

### TECHNICAL FIELD

This disclosure is directed to systems and methods for diagnostic testing involving a computing device. More specifically, the disclosure is directed toward systems and methods for performing analytic tests with a diagnostic system configured to communicate with a portable multifunctional device (PMD) or other computing device.

### BRIEF DESCRIPTION OF THE DRAWINGS

FIG. 1 depicts a simplified schematic representation of a system for diagnostic testing;

FIGS. 2 and 3 depict simplified perspective views of systems for diagnostic testing;

FIGS. 4 through 6 and 7A through 7C depict simplified perspective views of sample carriers;

FIGS. 8A, 8B, 9A, 9B, 10A, and 10B depict simplified representations of electrochemical detection; and

FIGS. 11 through 13 depict simplified representations of electrical systems of diagnostic systems.

### DETAILED DESCRIPTION

Developments in diagnostics, smart phones, and wireless communication are converging on a new way of conducting medical diagnostics. Just one example of the role smart phones and disseminated diagnostics technology may play in our lives in the future is the multitude of medical applications that have been created to serve the growing population of smart-phone users. Of the almost one million medical apps (software applications) currently available, over 80% appear to be geared toward exercise and biometrics. The majority of the apps are reference applications that are static and that cannot freely accept, interpret, or provide personalized information about the user. Additionally, most patients diagnosed for a particular medical issue do not immediately have access to a tailored treatment program or to a support system surrounding that treatment. Quality healthcare in the form of powerful, simple, affordable tools on handheld or other portable computing devices may provide enhanced connections between individuals that harness the potential of the Internet and digital technology.

The disclosure relates to devices, systems, and methods for performing diagnostic tests. Disclosed diagnostic systems are capable of performing analytic tests and communicating with a portable multifunctional device (PMD) or other computing device. For example, in some embodiments, a coupling and/or connection between an analyzer and a PMD allows a user (e.g., a medical provider) to access and use various rapid, user-friendly, and portable testing platforms. A wide range of settings and/or testing parameters may be employed, and the need for conventional analytic and diagnostic hardware and/or equipment may be minimized or negated, resulting in reduced medical costs and increased portability and accessibility of diagnostic tests.

The use of an analyzer and discrete sample cartridges as disclosed herein offers various advantages in diagnostic testing. For example, the analyzer can include electrical components, and can be configured to transmit electrical signals between the PMD and a sample cartridge. Through the analyzer, the PMD can initiate a diagnostic test sequence in a sample cartridge. The analyzer can also transmit the results of the diagnostic test from the sample cartridge back to the PMD.

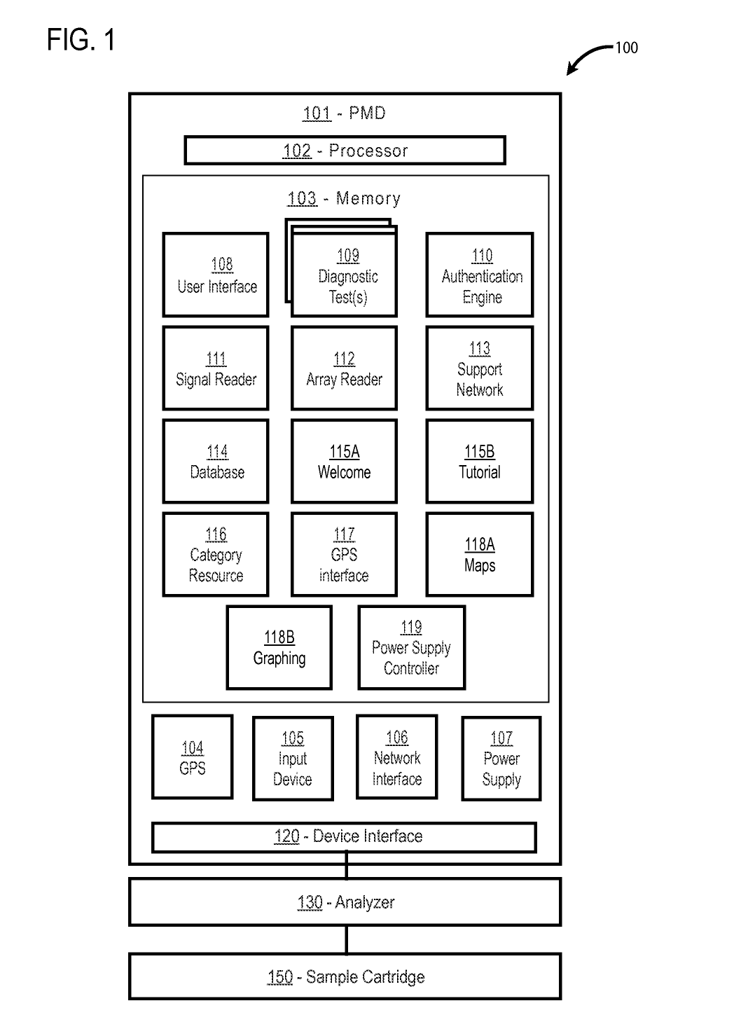

FIG. 1 is a simplified schematic representation of a system 100 for diagnostic testing. As shown in FIG. 1, the system 100 may include a computing device, such as a PMD 101, and an analyzer 130. At a user's discretion, one or more sample cartridges 150 may be coupled to the analyzer 130, and a range of diagnostic tests may be performed. For example, the analyzer 130 may be configured to transmit electrical signals between the PMD 101 and a sample cartridge 150, enabling various analytic applications to be provided. These analytic tests may include, but are not limited to, sensing or quantification of biological analytes or other chemicals from a sample input, whether gaseous, liquid, or otherwise, sensing or quantification of analytes, antibodies, or antigens, sensing or quantification of genetic material, or other substances.

A user interface 108 may be included on the PMD 101 to allow the user to control some aspects of the analyzer 130 and/or sample cartridge 150, and may present the results or measurements obtained from sample cartridge 150 via the analyzer 130 to the user. This user interface 108 may also provide information about resources, organizations, or people to the user, which may be of interest, assistance, or support to the user in reference to and/or based on a diagnostic test result.

The PMD 101 may include, but is not limited to, a “smart” mobile telephone (e.g., an iPHONE®, an ANDROID® telephone, etc.); a tablet computer (e.g., an iPAD®, an ANDROID® tablet, etc.), a computer, a portable digital assistant (PDA, e.g., Palm, iPOD® Touch, etc.), or portable computer (e.g., laptop), or another PMD or “smart” mobile device. In other embodiments, the PMD may be a desktop computing device. In still other embodiments, the PMD may be a customized and/or specific computing device.

The PMD 101 may provide a plurality of functions related to the diagnostic system 100. The PMD 101 may control or enable operation of the analyzer 130 and/or sample cartridge 150, such as through automated computing device control, manual control from the user through the PMD 101, or combination of both. In some embodiments, the PMD 101 may provide power to the analyzer 130 and/or sample cartridge 150, which may actuate the analyzer 130 and/or sample cartridge 150, and in some instances, allow for movement of components or materials within the analyzer 130 and/or sample cartridge 150. For example, in some embodiments, the PMD 101 may 1) power and/or control fluid pump and valve systems in the sample cartridge 150 to control the movement of reagents, solutions, suspensions and/or other liquids in the sample cartridge 150; 2) power and/or control circuitry and/or electrical systems in the analyzer 130 and/or sample cartridge 150; 3) power and/or control a mechanism to transfer a sample such as a fluid from a sample carrier; 4) power and/or control resistors to create temperature changes (such as for thermal cycling); 5) power and/or control mixing and/or rehydrating components to produce a measurable signal; 6) supply electricity for electrochemical detection; 7) power and/or control the purifying of suspensions through an on-device filtration process; and so forth. In some embodiments, for example, electrical current may be supplied to the analyzer 130 and/or sample cartridge 150 from the PMD 101 through one or more connection points (e.g., interfaces). Similarly, function commands and other inputs may be received by the analyzer 130 and/or sample cartridge 150 through electrical or other connections with the PMD 101.

The PMD 101 may also control a self-powered analyzer 130 and/or sample cartridge 150 that derives power from an external source other than the PMD 101. The PMD 101 may house and run a software interface, which may allow the user to control aspects of the analyzer 130 and/or sample cartridge 150, view test results, access information about resources in reference to these test results, and communicate test results and associated user information to other data collection sites or to service providers. The PMD 101 may receive electronic signals from the analyzer 130 and/or sample cartridge 150 related to the materials within the analyzer 130 and/or sample cartridge 150 and process these signals, and may display this processed data to the user through, for example, a user interface 108.

The PMD 101 may include a processor 102, a memory 103, a display 104, an input device 105 (e.g., a keypad, microphone, etc.), a network interface 106, a power supply 107 (e.g., a battery), and a device interface 120 (e.g., a docking port or other communication coupling mechanism). The PMD 101 may further include a plurality of modules or other components configured to perform a variety of functions and/or operations for diagnostic testing. The modules may be stored in the memory 103, as shown in FIG. 1. In other embodiments, the modules may comprise hardware components.

The modules or components may include, but are not limited to, a user interface 108, one or more diagnostic test(s) 109, an authentication engine 110, a signal reader 111, an array reader 112, a support network module 113, a database 114, a welcome module 115A, a tutorial 115B, a category resource engine 116, a global positioning system (GPS) interface 117, a maps module 118A, a graphing module 118B, a power supply controller 119, and other components.

The user interface 108 may present information on the display 104 and facilitate user input via the input device 105.

The one or more diagnostic test(s) 109 may be embodied as a test engine. The one or more diagnostic test(s) 109 may generate and display (e.g., via the user interface 108 on the display 104) instructions on procedures associated with performing a diagnostic test through a plurality of mechanisms, and may trigger or be triggered by other modules or components.

The authentication engine 110 may read unique signatures from the analyzer 130 and/or sample cartridge 150 inserted into the PMD 101, and may generate and display forms in which the user may add input, or which may be static forms. The authentication engine 110 may also trigger or be triggered by other modules or components.

The signal reader 111 may read, process, or interpret electronic signals at pins of the device interface 120 (or port) of the PMD 101 that may correspond to diagnostic information. The signal reader 111 may also trigger or be triggered by other modules or components.

The array reader 112 may read, process, or interpret information or data contained within arrays of data generated by other modules or components. The array reader 112 may also trigger or be triggered by other modules or components.

The support network module 113 may trigger and control various other modules or components that may allow the user to identify, locate, and access data describing resources contained within the support network module 113 and/or or third parties. The support network module 113 may also trigger or be triggered by other modules or components.

The database 114 may store data and/or forms in which the user may add input, or which may be static forms. The database 114 may also read, process, interpret, package, and transmit user input into arrays stored within an application or memory 103 or may transmit to third parties via the Internet. The database 114 may also trigger or be triggered by other modules or components.

The welcome module 115A may generate and display forms in which the user may add input, or which may be static forms. The tutorial 115B may also retrieve data and display data, including, but not limited to, text, images, and videos that may instruct use of (or interaction with) other modules or components. The welcome module 115A and the tutorial 115B may also trigger or be triggered by other modules or components.

The category resource engine 116 may generate and display forms in which the user may add input, or which may be static forms. The category resource engine 116 may also retrieve data and display data including but not limited to text, images, and videos. The category resource engine 116 may generate and display location-specific information based upon other hardware and/or software in the PMD 101 (e.g., such as a GPS interface 117). The category resource engine 116 may also trigger or be triggered by other modules or components.

The GPS interface 117 may enable capture, acquisition, and/or generation of location information.

The maps module 118A may manage and present maps, for example, in connection with displaying location information generated by the GPS and/or location information of resources as specified in, for example, the database 114. The graphing module 118B may manage and present data, such as, but not limited to, a single patient's test results as a function of time, an aggregation of patient data with population norms, or an aggregation of data from other locations.

The power supply controller 119 may operate to determine and/or provide power from the power supply 107 to the analyzer 130.

The analyzer 130 can be configured to couple to the PMD 101. The analyzer 130 can be configured as a multi-use or reusable analyzer 130. The analyzer 130 can also be described as being non-consumable, as the components of the analyzer 130 are not consumed by performing a diagnostic test. In some embodiments, the analyzer 130 can comprise a fuel cell, such as a battery, which may provide power to the analyzer 130, the sample cartridge 150, and/or the PMD 101. The analyzer 130 can also comprise one or more electrical systems that can include electrical circuits and/or electrical components. The electrical systems of the analyzer 130 can be used to transmit or otherwise transfer electrical signals between the PMD 101 and the sample cartridge 150.

The sample cartridge 150 may be configured to receive and retain a test sample. For example, the sample cartridge 150 can retain a solution in which a test sample is dissolved or otherwise dispersed. The sample cartridge 150 may include an electrode or other sensor capable of performing a diagnostic test on the test sample. The sample cartridge 150 can also transmit electrical signals to, and receive electrical signals from, the PMD 101 via the analyzer 130.

In some embodiments, the sample cartridge 150 is consumable. In other words, the sample cartridge 150 can be configured for a single use. For example, a test sample can be collected and disposed inside of the sample cartridge 150. The sample cartridge 150 can thereafter be coupled to the analyzer 130 and one or more diagnostic tests may be performed. After completion of the diagnostic test, the sample cartridge 150 can be withdrawn from the analyzer 130 and discarded. Another sample cartridge 150 containing another test sample can thereafter be coupled to the analyzer 130 and used in like manner.

In some instances, the sample cartridge 150 can be provided by a manufacturer in large quantities or lots. In some embodiments, each lot can include a control sample cartridge that can be used to calibrate the remainder of the sample cartridges 150 in the lot. In other embodiments, the lot of sample cartridges 150 can be calibrated by calibrating a single sample cartridge 150 within the lot against a known control sample. The remainder of the lot of the sample cartridges 150 may not require individual calibration. In yet other embodiments, the sample cartridges 150 can be configured with a control electrode and control sample disposed inside of the sample cartridge 150, similar to the control sample described in International Patent Publication No. 2014/008316 A2, published Jan. 9, 2014, and titled “Devices, Systems, and Methods for Diagnostic Testing,” the contents of which are incorporated herein by this reference.

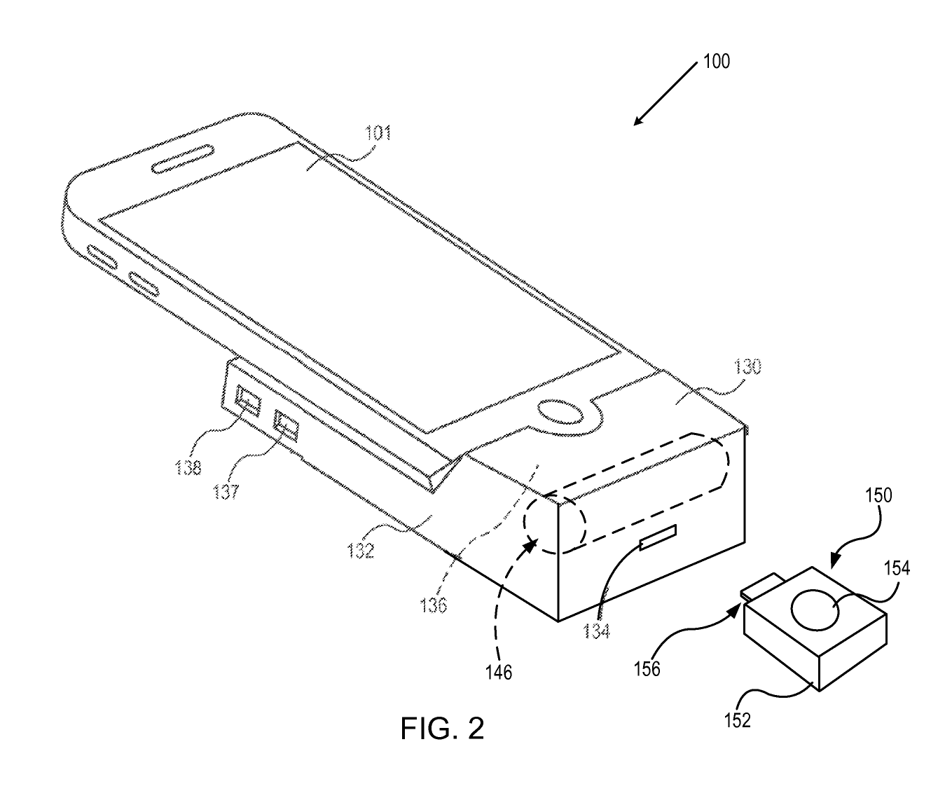

FIG. 2 depicts a perspective view of the diagnostic system 100 of FIG. 1. As shown in FIG. 2, the system 100 comprises a PMD 101 coupled to an analyzer 130. The PMD 101 can be coupled to the analyzer 130 in various ways. For example, the analyzer 130 can include a first interface 136, as shown by a dashed line, configured to mate with or otherwise couple to an interface on a PMD 101 or other computing device. For example, the first interface 136 of the analyzer 130 may be configured to mate with a computer bus, input/output port, power port, and/or other communication port of a PMD 101. As used herein, the term “interface” may be used to describe physical, electrical, magnetic, and/or fluid connections. Software related interfaces are also disclosed herein.

In some embodiments, the first interface 136 may be compatible with an input/output port on a smart phone or other smart mobile device. For example, the first interface 136 may be configured to couple with an Apple LIGHTNING® connection interface. In some embodiments, the first interface 136 may be configured to couple with a 30-pin connection interface. In yet other embodiments, the first interface 136 may be configured to couple with a standard or miniature universal serial bus (USB) connection interface. In still other embodiments, the first interface 136 can be an audio type interface such as a TS, TRS, or TRRS interface. Other standard or proprietary interfaces can also be used. Electrical power, electrical signals (e.g., input/output signals), and so forth, may pass between the analyzer 130 and the PMD 101 via the interface 136.

The analyzer 130 may include a housing 132, which may be referred to as a body member or casing structure. The housing 132 may be composed of various materials. For example, the housing 132 may include polymeric materials (e.g., plastics), metallic materials, glass materials, carbon fibers, and/or combinations thereof. Other materials may also be used.

The housing 132 may be used to retain the various components of the analyzer 130. For example, the housing 132 may contain an electrical system including one or more electronic circuits and/or circuit boards. The electrical system may function substantially similar to a potentiostat, electronic hardware that may be used to run electrochemical experiments. The housing 132 may also contain a fuel cell, such as a battery or rechargeable battery pack.

The housing 132 can include one or more ports 137, 138. In some embodiments, a port 137, 138 can be used to couple the analyzer 130 to a power source (e.g., power outlet). The power source may be used to provide power to the analyzer 130 and/or other components of the system 100. In some embodiments, the power source can be used to charge a rechargeable battery pack disposed within the analyzer 130. The power source can also be used to charge a rechargeable battery pack disposed within the PMD 101 or other computing device.

In some embodiments, a port 137, 138 may be used as a network connection port. In such embodiments, the port 137, 138 can be used to couple the analyzer 130 to a network such as a computer system or medical instrument via a cable (e.g., an Ethernet cable). The port 137, 138 may also be used for other purposes. In some embodiments, the analyzer 130 can include a first port 137 to couple the analyzer 130 to a power source, and a second port 138 to couple the analyzer 130 to a network.

The analyzer housing 132 can also comprise one or more additional components and/or features as desired. Other components and/or features can also be included, including stands, hand grips, carrying handles, switches (e.g., a power switch), status indicators (e.g., LED (light-emitting diode) status indicators), etc.

As further shown in FIG. 2, a sample cartridge 150 can also be coupled to the analyzer 130. For example, the analyzer 130 can include a second interface 134 configured to mate with or otherwise couple to an interface 156 of the sample cartridge 150. Any proprietary or standard interfaces (e.g., USB, mini-USB, etc.) can be used. Through the second interface 134 of the analyzer 130 and the interface 156 of the sample cartridge 150, electrical signals may be transmitted between the analyzer 130 and the sample cartridge 150.

The sample cartridge 150 may include a housing 152 on which or in which a test sample can be disposed. Various sample types can be used, including, without limitation, blood, serum, urine, fecal matter, semen, saliva, nasal swabs, nasopharyngeal swabs, buccal swabs, throat swabs, and other biological and/or chemical samples. In some embodiments, the sample cartridge 150 may contain all of the equipment and means (e.g., pumps, valves, reagents, etc.) to perform an electrochemical test. Furthermore, the sample cartridge 150 may interface with the PMD 101 directly or via the analyzer 130.

In some embodiments, the sample cartridge 150 includes an electrode 154 or other sensor configured for sensing and/or detecting one or more analytes, including proteins, nucleic acid sequences, ions, cells, and/or other biological and/or chemical analytes.

In some embodiments, the sample cartridge 150 may include embedded software or firmware. Embedded software can function as a signature for a particular sample cartridge 150. For example, embedded software of a sample cartridge 150 may provide the PMD 101 or other computing device with identifying information about the sample cartridge 150 (e.g., lot number, sample type, etc.). The embedded software of the sample cartridge 150 may also signal and/or trigger certain events within the PMD 101 and/or the analyzer 130.

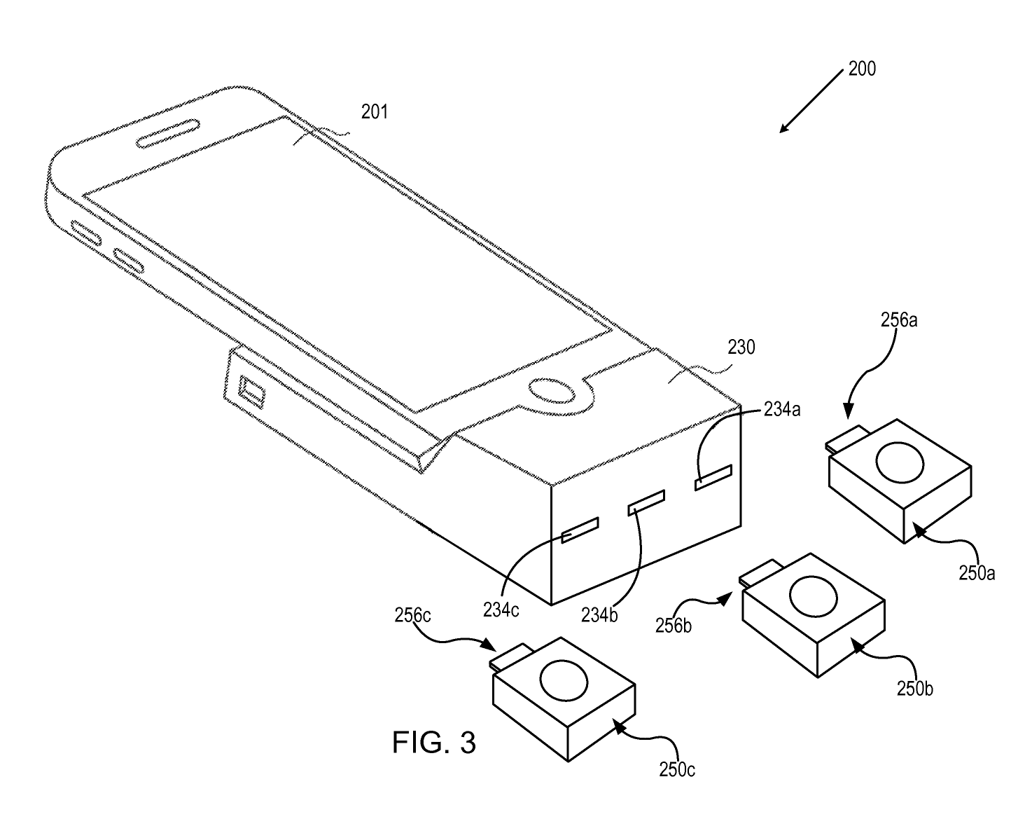

FIG. 3 is a perspective view of a system 200, according to another embodiment. An analyzer 230 may be configured to be coupled to a PMD 201 and to a plurality of sample cartridges 250. The analyzer 230 is shown as configured to be coupled to three sample cartridges 250a, 250b, 250c via three interfaces 234a, 234b, 234c. Other configurations are also possible. For example, the analyzer 230 can be configured to be coupled to two sample cartridges 250, or four or more sample cartridges 250. By being configured to couple to multiple sample cartridges 250, high volumes of diagnostic tests can be performed by a single PMD 201 and analyzer 230 in a short amount of time. In some embodiments, the system 200 can be configured such that multiple diagnostic tests can run in parallel. For example, diagnostic tests can be performed on three sample cartridges 250a, 250b, 250c in parallel. The plurality of diagnostic tests can be run simultaneously, or at substantially the same time (e.g., with staggered start times). The plurality of diagnostic tests can also be run independently from other tests in progress. Additionally, the three sample cartridges 250a, 250b, 250c can contain test samples from the same or multiple patients.

The interfaces 234a, 234b, 234c may be configured to mate with or otherwise couple to an interface 256a, 256b, 256c of a sample cartridge 250a, 250b, 250c. Electrical signals can be transmitted to and from the respective sample cartridges 250a, 250b, 250c through these interfaces 256a, 256b, 256c.

In yet another embodiment, the PMD 101 (FIGS. 1 and 2) or other computing device may be configured to couple to a plurality of analyzers. Each of the plurality of analyzers can be configured to couple to one or more sample cartridges.

The analyzer 130 may also include a fuel cell 146, such as a rechargeable or replaceable battery pack. In other embodiments, the fuel cell 146 can include one or more standard batteries that may be inserted into the analyzer housing 132. As previously discussed, the fuel cell 146 can provide power to the analyzer 130. The fuel cell 146 can also provide power to the PMD 101 and/or a sample cartridge 150. The properties of the fuel cell 146 may vary as desired. For example, the fuel cell 146 can be various shapes and/or sizes. The voltage, charging capacity, and/or other properties can vary.

In some embodiments, the electrode 154 or other sensor may be bound and/or coupled to capture probes, which may include a peptide and/or another chemical entity. The chemical entity may allow indirect and/or direct binding of the peptide to the electrode 154. For example, the chemical entity may include a thiolated hydrocarbonchain which may be bound to the N-terminus of a peptide. The C-terminus of the peptide may be modified and bound with a plurality of chemical agents including, but not limited to, a redox agent such as methylene blue. In some embodiments, the peptide may have a chemical affinity for one or multiple entities in the sample solution. When there is no bond between these entities and the peptide, the peptide may be highly flexible, and may efficiently achieve electron transfer to and from the redox agent. When there is a bond between these entities and the peptide, the peptide may become less flexible, and, in binding this entity, may lose the ability or efficiency of electron transfer to and from the redox agent through a plurality of mechanisms including, but not limited to, being physically and chemically obstructed by the bound entity, or moved a sufficient distance away from electrode 154. In some embodiments, the sample cartridge 150 also includes a solution capable of unbinding the peptide from the entity.

In other embodiments, the electrode may include a DNA sensor such as an aptamer. In such embodiments, the electrical conductivity of DNA and/or other oligonucleotide constructs is dependent on its conformational state. For example, upon binding or otherwise incorporating an analyte from a sample, the conformation of the DNA sensor may switch, thereby resulting in an altered conductive path between two oligonucleotide stems. An electrode 154 or other sensor may be used to monitor the electron transfer. This electrochemical detection methodology is further described in U.S. Pat. No. 7,947,443, issued May 24, 2011, and titled “DNA and RNA Conformational Switches as Sensitive Electronic Sensors of Analytes;” and U.S. Pat. No. 7,943,301, issued May 17, 2011, and titled “DNA Conformational Switches as Sensitive Electronic Sensors of Analytes;” the contents of each of which are incorporated herein by this reference.

In other embodiments, the detection method can include colorimetry and/or fluorimetry (i.e., the sample cartridge 150 and/or analyzer 130 (FIG. 2) can include a colorimeter and/or a fluorometer). The colorimeter and/or fluorometer can be coupled to other components within the sample cartridge 150 and/or analyzer 130, and may be used to analyze various sample types.

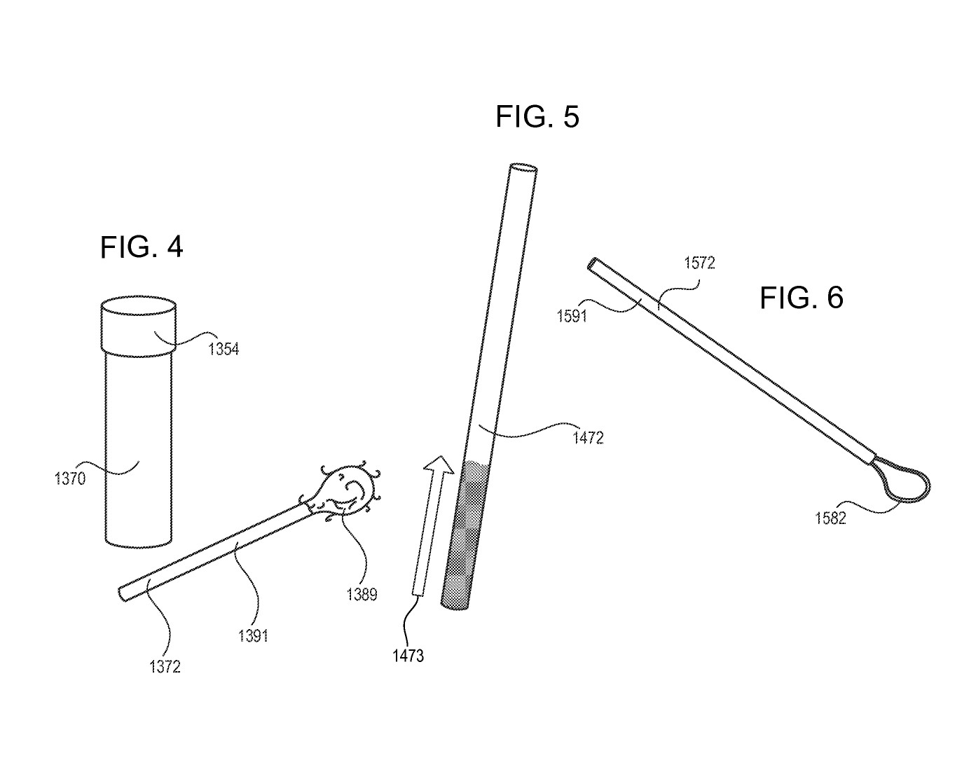

FIGS. 4, 5, and 6 depict various sample carriers 1372, 1472, and 1572 that may be used in accordance with the present disclosure. For example, in FIG. 4, the sample carrier 1372 comprises an absorbent swab 1389 disposed at the end of a handle, stick, or shaft 1391. In some embodiments, the absorbent swab 1389 may be a flocked swab comprising nylon or another absorbent material. The absorbent swab 1389 may be configured to absorb a test sample prior to delivery to a sample cartridge 150 (FIG. 2), and may thereafter be brought into contact with the electrode 154 of the sample cartridge 150. In some embodiments, a buffer solution (e.g., within a sample container 1370) may be used to elute the test sample from the absorbent swab 1389. In other embodiments, one or more components of the diagnostic device may be configured to squeeze and/or otherwise release the test sample from the absorbent swab 1389 and onto or into a sample cartridge 150.

A sample container 1370 may have a tubular member and a cap 1354. The cap 1354 may be configured to seal or close the sample container 1370 either reversibly or irreversibly. In some embodiments, the cap 1354 may be screwed or twisted onto the sample container 1370. In other embodiments, the cap 1354 may be snapped onto the sample container 1370 via a snap-fit connection.

In some embodiments, the sample container 1370 may be configured for use without a separate sample carrier 1372. For example, a solid sample may be disposed and dissolved in a buffer solution within the sample container 1370. The sample container 1370 may thereafter be introduced to a sample cartridge 150 and an analysis of the test sample may be performed.

FIG. 5 depicts another sample carrier 1472. As shown in FIG. 6, the sample carrier 1472 may include a capillary tube. As indicated by the reference arrow 1473, a fluid sample may be drawn into the capillary tube and collected via capillary action. A solid sample may also be collected in the capillary tube, if desired. In some embodiments, the capillary tube may be disposed into a sample container comprising a buffer solution (such as the sample container 1370 depicted in FIG. 4) prior to being delivered to a sample cartridge 150. In other embodiments, the capillary tube may be delivered directly to a sample cartridge 150 for diagnostic testing.

FIG. 6 depicts yet another sample carrier 1572. As shown in FIG. 6, in some embodiments, the sample carrier 1572 comprises a handle 1591 and a terminating loop 1582. The loop 1582 may collect a plurality of samples (e.g., fluid and/or solid samples). In some embodiments, the loop 1582 may be disposed into a sample container comprising a buffer solution (such as the sample container 1370 depicted in FIG. 4) prior to being delivered to a sample cartridge 150 (FIG. 2). In other embodiments, the sample carrier 1572 comprising the loop 1582 may be delivered directly to a sample cartridge 150 for diagnostic testing.

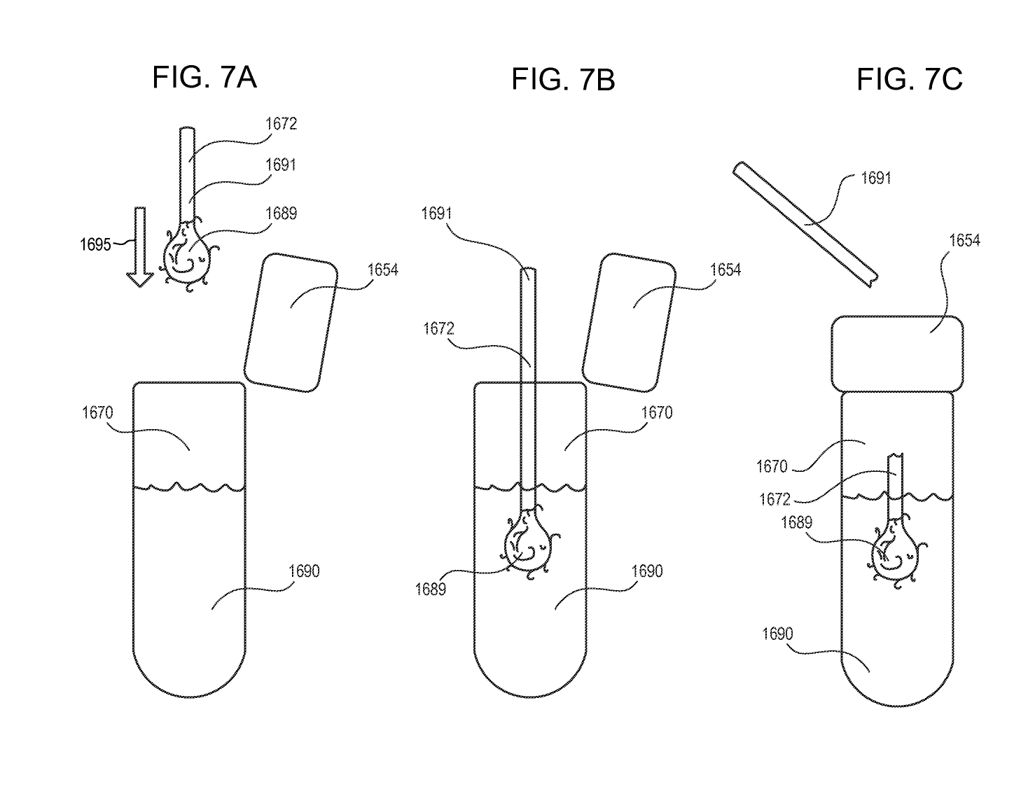

FIGS. 7A through 7C depict another sample carrier 1672. The sample carrier 1672 may include an absorbent swab 1689 and a handle 1691. The sample carrier 1672 may be inserted into a sample container 1670, which may be a test tube with a cap 1654. The sample container 1670 may be at least partially filled with a buffer solution 1690.

In FIG. 7A, the sample container 1670 is depicted in an open configuration in which the cap 1654 is removed and the sample container 1670 is open. While the sample container 1670 is in the open configuration, the sample carrier 1672 may be inserted, as indicated by the reference arrow 1695. In FIG. 7B, the sample carrier 1672 is partially disposed within the open sample container 1670 and the buffer solution 1690. Further, a portion of the handle 1691 is shown protruding outwardly from the sample container 1670. In some embodiments, this protruding portion of the handle 1691 may be broken or otherwise removed from the sample carrier 1672 so that the cap 1654 can be used to close or seal the sample container 1670, as shown in FIG. 7C. In other embodiments, the handle 1691 is short enough to fit in the sample container 1670 such that it need not be broken off. In FIG. 7C, the sample container 1670 is depicted in a closed configuration in which the cap 1654 has been used to close or seal the sample container 1670. The protruding portion of the handle 1691 has been broken and removed from the sample carrier 1672, and the absorbent swab 1689 remains disposed and immersed within the buffer solution 1690 inside of the sample container 1670.

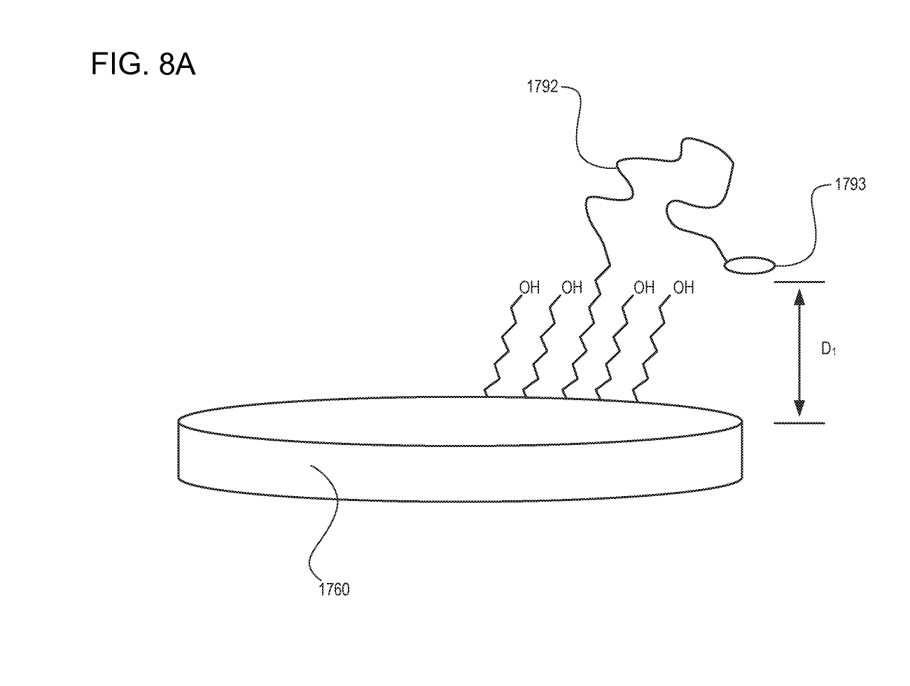

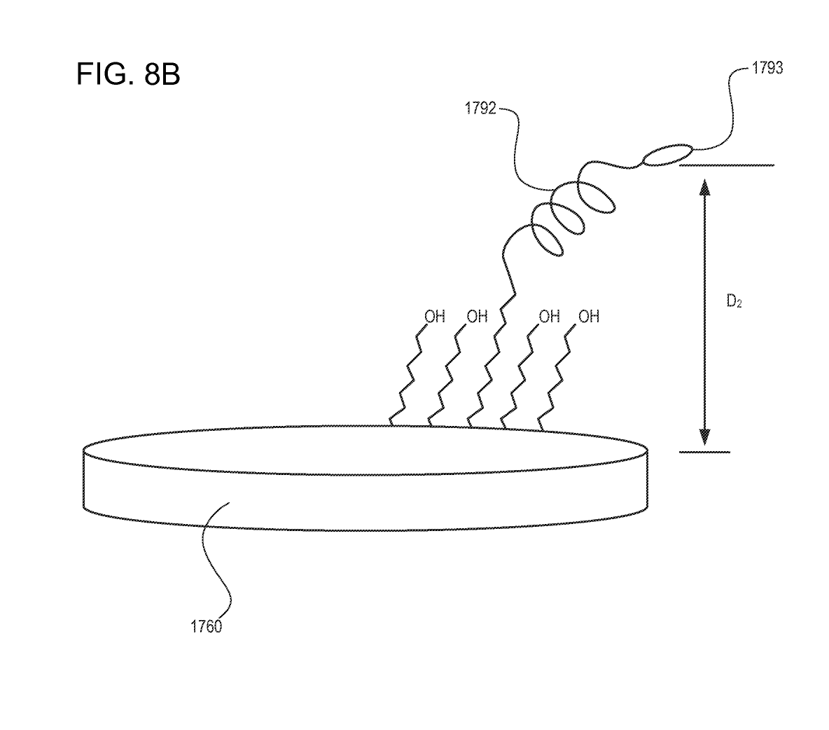

FIGS. 8A and 8B depict an illustrative representation of electrochemical detection, according to another embodiment of the present disclosure. In particular, FIGS. 8A and 8B depict an electrode 1760 configured to measure the transfer of electrons during a diagnostic test. Referring both to the system 100 shown in FIGS. 1 and 2 and to structural diagrams shown in FIGS. 8A and 8B, the system 100 may be sensitized to a specific diagnostic species as a consequence of biochemical components immobilized on the electrode 1760. For example, for an HIV test, HIV-specific peptides or proteins 1792 may be immobilized to an electrode 1760 in a sample cartridge 150. In one embodiment, the HIV-specific peptide or protein 1792 changes conformation upon binding an HIV antibody in the test sample introduced via the sample carrier from an amorphous structure to a polypeptide chain with defined structure (such as an alpha helix, beta strand, or beta sheet). Round to this peptide 1792 is redox-sensitive moiety 1793 that when attached to the amorphous peptide 1792, demonstrates a relatively high electron transfer rate (k_{ET}) in communication with the PMD 101. Upon antibody binding, the redox-sensitive moiety 1793 moves away from the electrode 1760 and the k_{ET} is dramatically reduced. For example, as shown in FIGS. 8A and 8B, distance D₂ is greater than distance D₁. As a consequence of the change in k_{ET} as detected by the PMD 101, this mechanism can be used to quantify antibodies in a patient sample.

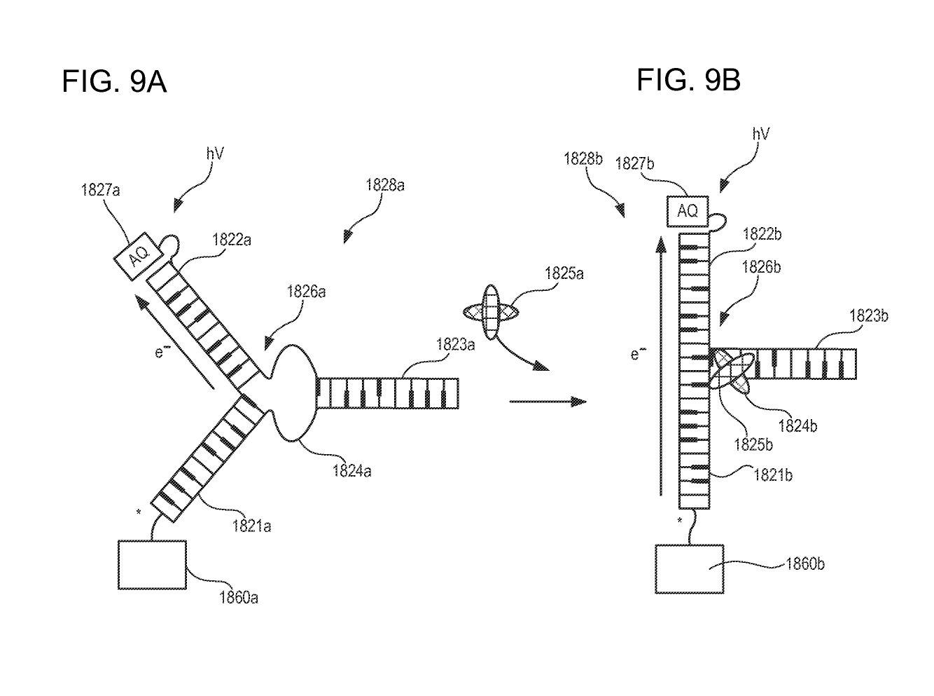

FIGS. 9A and 9B depict an illustrative representation of electrochemical detection, according to another embodiment. FIG. 9A depicts a sensor system 1828a in an unbound state (first conformational state), and FIG. 9B depicts the sensor system 1828b in a bound state (second conformational state). As shown in FIGS. 9A and 9B, a first oligonucleotide stem 1821a, 1821b and a second oligonucleotide stem 1822a, 1822b are connected together at a junction 1826a, 1826b. Stems 1821a, 1821b, 1822a, 1822b may comprise double-helical DNA or other nucleic acid constructs. The sensor system 1828a, 1828b may also include a third oligonucleotide stem 1823a, 1823b. The sensor system 1828a, 1828b includes a receptor 1824a, 1824b, which may form part of the junction 1826a, 1826b. The receptor 1824a, 1824b may include a nucleic acid aptamer sequence selected to bind to a target analyte.

The first stem 1821a, 1821b may function as an electron donor, and the second stem 1822a, 1822b may function as an electron sink (although the reverse configuration may also be employed). When an analyte 1825a, 1825b binds to a receptor 1824a, 1824b, a conformation change in the sensor system 1828a, 1828b occurs, resulting in a detectable change in charge transfer between respective first and second stems 1821a, 1821b, 1822a, 1822b. The conformational change may include adaptive folding, compaction, structural stabilization or some other steric modification of junction in response to analyte 1825a, 1825b binding, which causes a change in charge-transfer characteristics of the sensor system 1828a, 1828b.

As further illustrated in FIGS. 9A and 9B, the sensor system 1828a, 1828b may include a charge flow inducer 1827a, 1827b, which may include antraquinone (AQ) or rhodium (III) complexes with aromatic ligands, for controllably inducing charge transfer between respective first and second stems 1821a, 1821b, 1822a, 1822b in the second conformational state. Additionally, the sensor system 1828a, 1828b may be coupled to or otherwise attached to an electrode 1860a, 1860b disposed within a sample chamber of the diagnostic device. This electrochemical detection methodology is further described in U.S. Pat. Nos. 7,947,443 and 7,943,301, previously incorporated by reference.

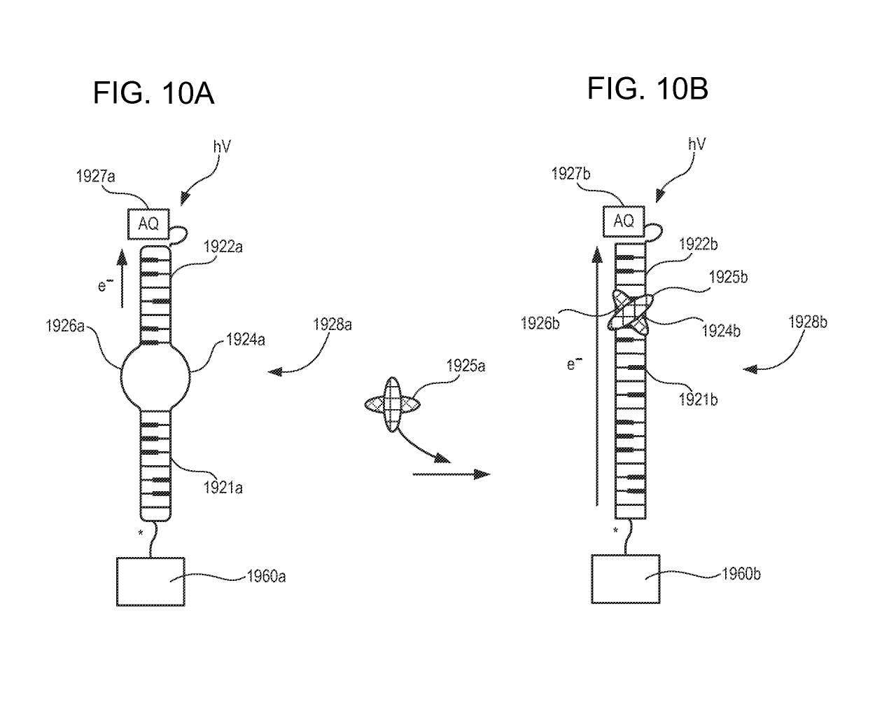

FIGS. 10A and 10B depict another illustrative representation of electrochemical detection. FIG. 10A depicts a sensor system 1928a in an unbound state (first conformational state), and FIG. 10B depicts the sensor system 1928b in a bound state (second conformational state). A first oligonucleotide stem 1921a, 1921b and a second oligonucleotide stem 1922a, 1922b are connected together at a junction 1926a, 1926b. The sensor system 1928a, 1928b further comprises a receptor 1924a, 1924b, which may form part of the junction 1926a, 1926b.

The first stem 1921a, 1921b may function as an electron donor, and the second stem 1922a, 1922b may function as an electron sink (although the reverse configuration may also be employed). When an analyte 1925a, 1925b binds to a receptor 1924a, 1924b, a conformation change in the sensor system 1928a, 1928b may occur, resulting in a detectable change in charge transfer between the first and second stems 1921a, 1921b, 1922a, 1922b. For example, prior to the binding of the analyte 1925a, 1925b, charge transfer between respective first and second stems 1921a, 1921b, 1922a, 1922b may be substantially impeded.

In some embodiments, the sensor system 1928a, 1928b may include a charge flow inducer 1927a, 1927b for controllably inducing charge transfer between respective first and second stems 1921a, 1921b, 1922a, 1922b in the second conformational state. Additionally, the sensor system 1928a, 1928b may be coupled to or otherwise attached to an electrode 1960a, 1960b disposed within a sample chamber of the diagnostic device. This electrochemical detection methodology is further described in U.S. Pat. Nos. 7,947,443 and 7,943,301, previously incorporated by reference.

As discussed above, the system may include a plurality of functional modules, including signal acquisition modules, signal packaging and recall modules, data transmission modules, PMD or other computing device interface modules, cartridge interface modules, analog-to-digital and digital-to-analog converters, current-to-voltage converters, sampling modules, batteries, battery charging modules, alternating current to direct current and direct current to alternating current converters, assay charging modules, waveform generation modules, and other functional modules.

The electrical circuit may have a plurality of functions and may be configured to include different functional modules. In one embodiment, the electrical circuit may have a module for acquiring signals from other modules within the system. In another embodiment, these signals may be recalled or packaged by modules within the system and transmitted to other modules. In a further embodiment, the electrical circuit may have a plurality of electronic interfaces, which may couple functional aspects of the system. The electrical circuit may have the capability to interface with one sample cartridge or with multiple sample cartridges simultaneously. The electrical circuit may allow for AC power input to charge components of the system. This AC power input may be converted to DC by an AC/DC converter. Likewise, the system may, in some embodiments, utilize a DC power input. This DC power input may be converted to AC by a DC/AC converter. In some embodiments, a DC/DC converter may be included and may modulate characteristics of power coming into the system. The electrical circuit may also receive power from one or a plurality of PMDs or other computing devices, which may be coupled to the electrical circuit through any one of a plurality of standard or proprietary electronic and physical interfaces. In some embodiments, the PMD or other computing device may interface with the analyzer, and may initiate and maintain a master-slave communication to carry out functions to conduct a plurality of electrochemical detection tests.

In one embodiment, the electrical circuit may charge the electrode through input signals, then may sample the output signal from the electrode system at discrete time intervals. The PMD or other computing device may direct functional modules within the circuit to modulate these input signals to the electrode. Modulations may include, but are not limited to, varying of voltage over time; alteration of shape of input signal including, but not limited to, waveform manipulations; offset; amplification; and other modulations. In one embodiment of the electrical circuit, these waveform manipulations may be accomplished by the inclusion of a waveform generation module, which may allow the creation of a plurality of waveforms, which vary signal characteristics of signal inputs over time. This manipulation may allow the electrical circuit to produce input signals including, but not limited to, linearly changing waveforms, sinusoidal waveforms, triangular waveforms, square waveforms, and other waveforms.

The electrical circuit may perform a plurality of different analytical measurement methods including, but not limited to, amperometry and square wave voltammetry. The electrical circuit may be directed by the PMD to adjust a plurality of sampling parameters that allow proper data collection from electrochemical reactions occurring within the reaction chamber. These sampling parameters may be adjusted based upon the detection method, and may include, but not be limited to, sample starting time, sample interval, sampling length, sampling frequency, and other sampling parameters. In some embodiments, functional modules within the electrical circuit may convert analog output signals from the electrode to digital signals suitable for transmission to the PMD or other computer device for further processing.

In another embodiment, the electrical circuit may transmit data pertinent to the PMD or other computing device, via any one of a plurality of transmission modules, either through physical electronic pathways, or wirelessly.

Output signals from the electrochemical assay may be converted either to voltage or current, or may be amplified, modulated, or otherwise modified to extract data that may be later processed to elucidate information about the electrochemical detection reaction.

In one embodiment, the electrical circuit may include a plurality of functional modules and components on one circuit board. In other embodiments, these modules and components may be situated upon multiple circuit boards, for reasons including, but not limited to, increasing a signal-to-noise ratio, improving performance of modules and components, decreasing required power of system, and for other reasons. As an exemplary configuration, modules and components involved in measurement, signal modulation, data transmission, or other functions requiring precision may be situated on one of the circuit boards, while another circuit board may include modules and components directed at providing power to the system, or other functional modules and components.

The functional modules within this electrical circuit may be contained within the analyzer, the sample cartridge, or may be any one of a plurality of arrangements between the two.

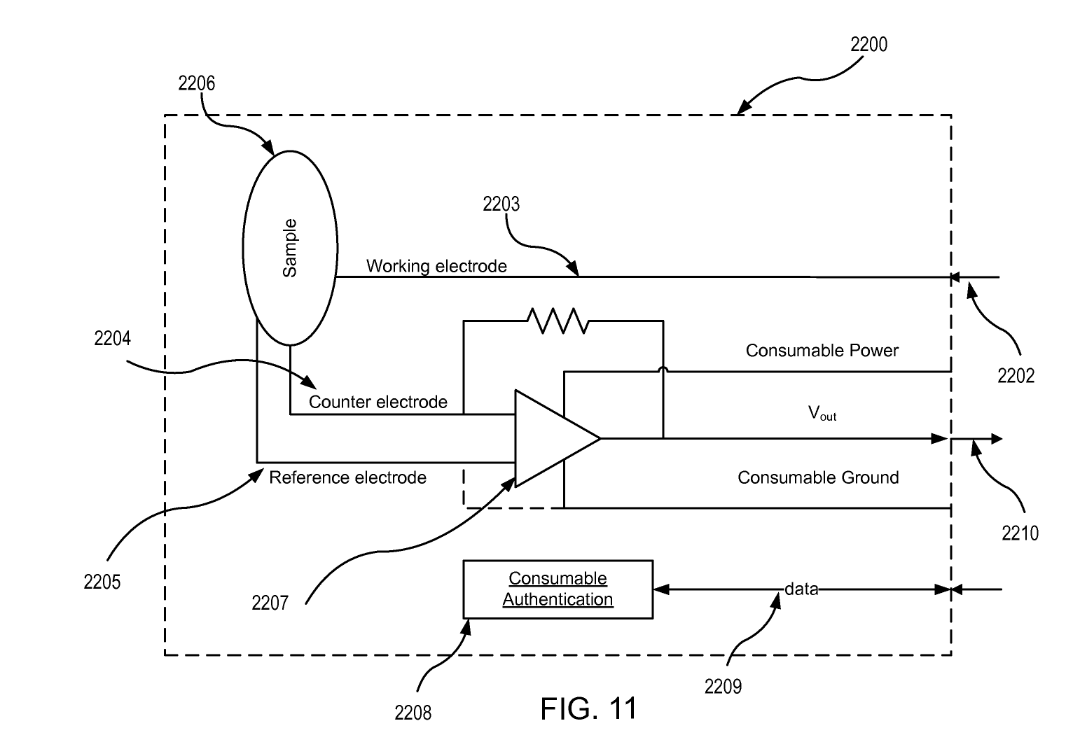

Illustrative electrical systems are shown in FIGS. 11 through 13. As shown in FIG. 11, the electrical system 2200 may include an input signal 2202 that: 1) may be voltage or current, 2) may have a plurality of waveforms and amplitudes, and 3) may originate from a plurality of sources, such as a working electrode 2203; counter electrode 2204; and reference electrode 2205; or other electrical components necessary for the electrochemical detection reaction; all of which may be electronically coupled with the sample 2206. The electrical system 2200 may also include one or more amplifiers or signal converters 2207, a microcontroller or microprocessor 2208, cartridge data 2209, or output signal 2210. Other elements can also be included. These functional components may be shielded or unshielded, depending on design requirements.

The input signal 2202 may originate from any of a plurality of sources, including a waveform generation module, a microprocessor, a voltage or current source, or another source. In some embodiments, the waveform generation module may be situated in a plurality of locations including within the analyzer 130 (FIG. 2), within software on the PMD 101 (FIGS. 1 and 2) or other computing device, within an external source, or in another location. The input signal 2202 may change with respect to time, and may have one of a plurality of waveforms including linear, exponential, sinusoidal, triangular, square, or other waveforms. Other characteristics of the input signal 2202 may also vary with time including phase, offset frequency, amplitude, and other characteristics. The input signal 2202 can serve a plurality of functions, including charging working electrode 2203 and other functions. This interface may also be a point of interface with external devices, circuits, or software.

The working electrode 2203 may include materials such as gold, platinum, carbon, silver, copper, or another material. The working electrode 2203 may conduct electronic signals from the electrical circuit to chemical species in the reaction chamber, contain the electrochemical reaction of interest, and may serve other functions.

The counter electrode 2204 may also be referred to as an auxiliary electrode, and may include similar materials to the working electrode 2203. A current or voltage may be exerted across the solution by applying a potential between the working electrode 2203 and the counter electrode 2204, and output signals from the counter electrode 2204 may be transmitted, modulated, stored, processed, and other otherwise used in detection.

The reference electrode 2205 may be composed of a plurality of materials, and may serve as a reference against which output signals are compared. In one embodiment, this reference may remain relatively constant throughout a reaction. In another embodiment, the reference electrode 2205 may be coupled with a feedback loop to modulate the reference values based upon characteristics and dynamics of the reaction.

The current/voltage converter 2207 may serve a plurality of functions, including conversion of current to potential, conversion of potential to current, and other functions. In some embodiments, this converter 2207 may modulate or otherwise modify output signals based on current or voltage from the counter electrode 2204 and reference electrode 2205. In some embodiments, the modulated signal may be transmitted to the analyzer, the PMD or other computing device, or to another location. In another embodiment, the converter 2207 may amplify output signals from the reaction chamber.

The data transfer module 2208 may include one or more components including microprocessors, microcontrollers, and other standard electronic components. The data transfer module 2208 may communicate with the analyzer 130 (FIG. 2), the PMD or other computing device, or other external device and may interface with these or other devices. In one embodiment, the data transfer module 2208 may store data 2209 related to the sample cartridge, analyzer, or other elements within the system, and may pass this information 2209 to the analyzer 130, PMD 101 (FIGS. 1 and 2), or other computing device, or to other devices. This data may cause the receiving device to adjust its own inputs, outputs, and operations.

The data 2209 may be stored on data transfer module 2208, and may include information including lot number, date, type of test, authentication information or electronic signature, quality control information, material information, and other information.

The output signal and interface 2210 may be an output from the reaction chamber, and may have been modulated by converter 2207 or to the components. This interface 2210 may serve as a means to transmit this signal to the analyzer, the PMD 101 or other computing device, or to another location.

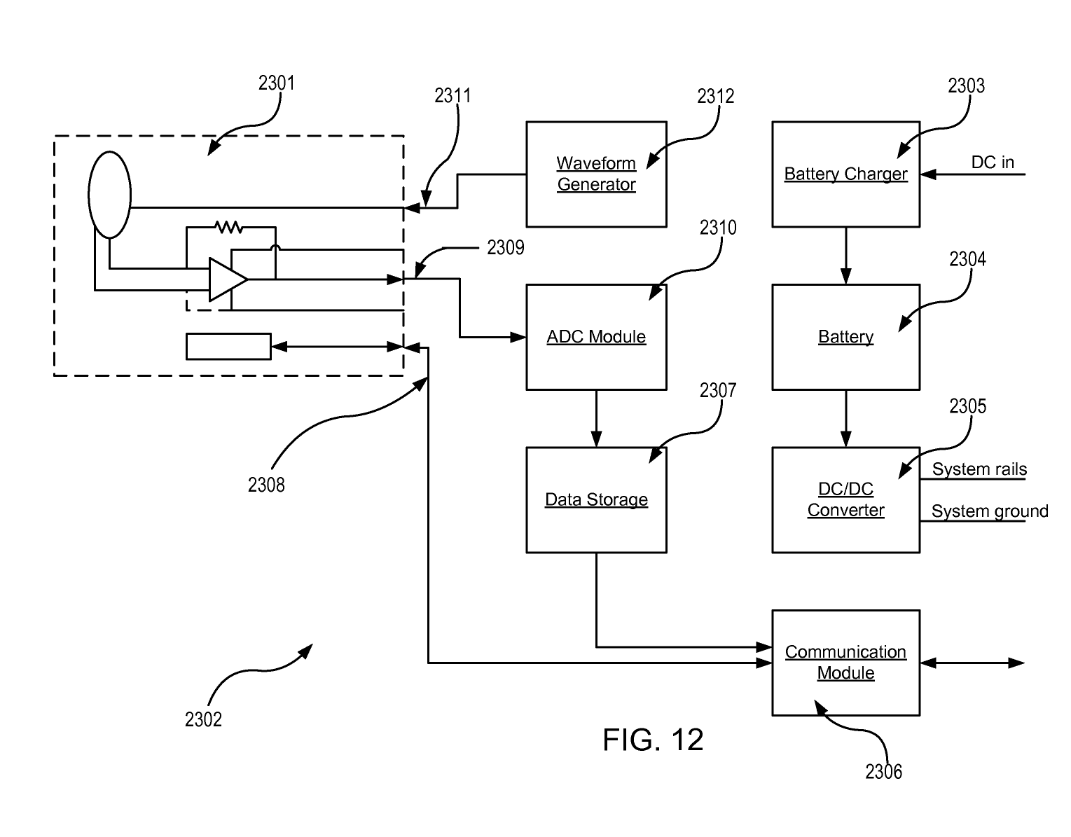

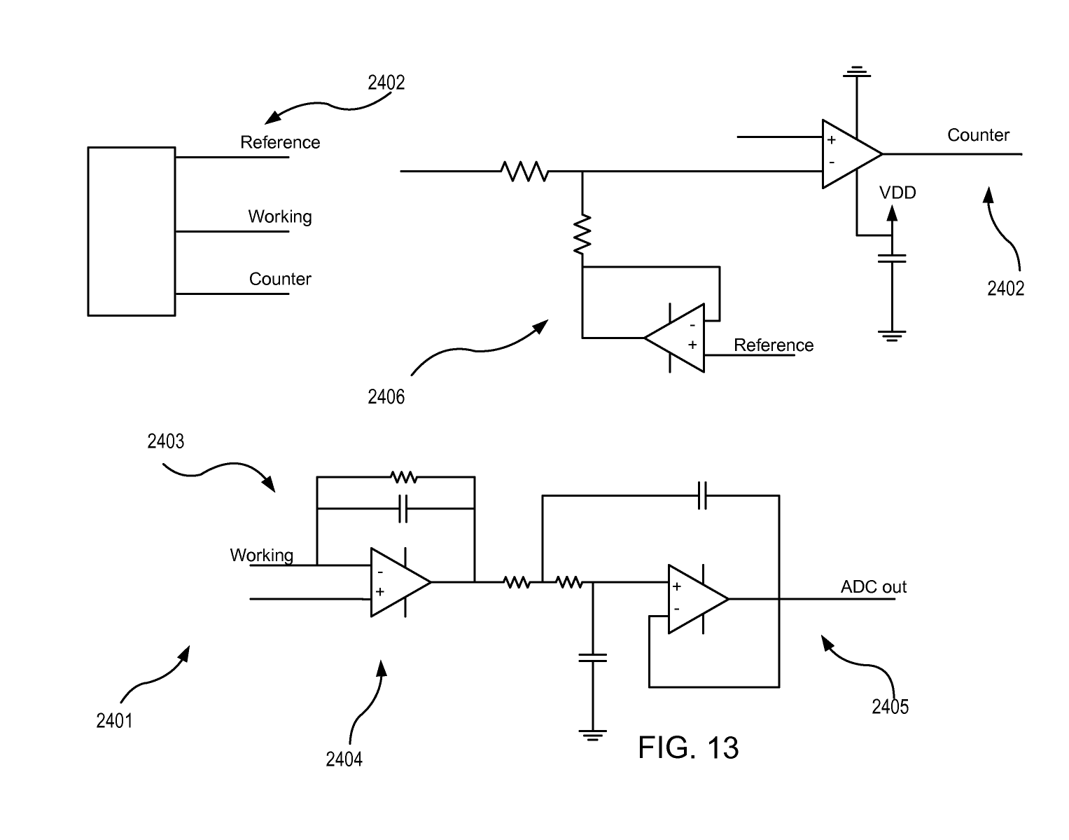

FIG. 12 is another illustrative embodiment of an electronic system 2302, which may allow communication between the electrochemical detection reaction and the PMD 101 (FIGS. 1 and 2) or other computing device. The electronic system 2302 may comprise a plurality of elements, including an electronic subsystem 2301 which, in one embodiment, may be spatially situated within a cartridge, a battery charger 2303, a battery module 2304, a power source converter module 2305, a PMD or other computing device communication module 2306, a data storage module 2307, a data transmission interface 2308, a signal output interface 2309, a signal conversion module 2310, a signal input interface 2311, a waveform generation module 2312, and any other functional modules or components. These functional components may be shielded or unshielded.

The electronic subsystem 2301 may be substantially equivalent to the electronic system 2200 of FIG. 11, but the electronic subsystem 2301 may be configured to interact with other electronic modules outside of the electronic subsystem 2301 to increase functionality of the subsystem 2301.

The battery charger 2303 may be configured to interact directly with a power source, such as a DC power source, an AC power source, an external battery, or other external power sources. In another embodiment, the battery charger 2303 may be configured to connect to a battery 2304. The battery charger 2303 may be configured to condition or modulate power from one of a plurality of external power sources to charge the battery 2304. In another embodiment, the battery charger 2303 can interface with a plurality of interfaces to provide power to the battery 2304 within the PMD 101 (FIGS. 1 and 2) or other computing device. In another embodiment, the battery charger 2303 may be substantially equivalent to the port 138 of FIG. 2, and may contain internal infrastructure suitable for interfacing with a plurality of interfaces, including computing devices, two- or three-prong outlets, or other interfaces. In a further embodiment, the battery charger 2303 may be part of a dock for the PMD 101 or other computing device. In some embodiments, power conversion components may be incorporated within the battery charger 2303.

The battery 2304 may be any type of battery, including alkaline, lithium ion, or another battery. In one embodiment, the battery 2304 may be non-rechargeable, and may require replacement after depletion. In another embodiment, the battery 2304 may be rechargeable, and may interface with the battery charger 2303 to receive power input. In another embodiment, the battery 2304 may power all processes, modules, and components within the system 2302, or may provide power to some processes, modules, and components. The battery 2304 may interface with a power source converter module 2305. In some embodiments, the battery 2304 may directly interface with other modules and components of the system 2302.

The module 2305 may convert power sources from AC to DC or from DC to AC as appropriate. The module 2305 may provide the system 2302 and the PMD 101 (FIGS. 1 and 2) or other computing device with power within a range suitable for optimal operation of processes, modules, and components within each.

In some embodiments, a standard or proprietary interface may provide a means of data passage and communication between a PMD or other computing device and the PMD communication module 2306. Module 2306 may contain a microprocessor or microcontroller to establish a master and slave protocol between the PMD or other computing device and the analyze' 130 (FIG. 2). For example, software on the PMD or other computing device may communicate with the module 2306 to direct activity of the analyzer and, by extension, the sample cartridge and electrochemical assay. In other embodiments, the module 2306 may also pass data to the PMD 101 (FIGS. 1 and 2) or other computing device. The module 2306 may interact with a plurality of modules, processes, and components within the PMD 101 or other computing device, the analyzer, and the sample cartridge, including the module 2308 and module 2307.

The data storage module 2307 may store data from other modules, processes, and components. In one embodiment, the module 2307 may receive data from subsystem 2301, and may store, package, and deliver these data to other modules within the system 2302. The data storage module 2307 may receive data directly from the subsystem 2301 and pass the data along to the module 2306 for communication to the PMD 101 (FIGS. 1 and 2) or other computing device. In another embodiment, data from the subsystem 2301 may be converted from an analog signal to a digital signal and passed along to module 2307. Module 2307 may then create a package or array comprising data and pass it along to module 2306 for further processing. Module 2307 may also provide packets of data to other modules in the system in a plurality of sizes.

The data transmission interface 2308 may be substantially equivalent to module 2208 described above and shown in FIG. 11, and in some embodiments, may communicate data 2209.

The output signal interface 2309 may be substantially equivalent to module 2210 described above and shown in FIG. 11, and in some embodiments, may transmit data to the signal conversion module 2310 the data storage module 2307, or to another module for modulation or processing.

The signal conversion module 2310 may import data in analog format and output a digital signal. In doing so, the module 2310 may, in some embodiments, provide module 2307 with a set of discrete values corresponding to output signals from subsystem 2301 that may be stored, packaged, and transmitted to other modules within the system 2302 and to external locations.

The signal input interface 2311 may be substantially equivalent to module 2302, and in some embodiments, may receive modulated signals from a plurality of sources including waveform generation module 2312, a power source or battery 2304, a power source converter module 2305, or from other sources.

The waveform generation module 2312 may be substantially equivalent to the waveform generation module 2312 described above and shown in FIG. 12. The waveform generation module 2312 may also be a point of interface with external devices, circuits, or software.

FIG. 13 is an illustrative diagram of aspects of an electronic system, which may allow communication between the electrochemical detection reaction and the PMD 101 (FIGS. 1 and 2) or other computing device.

The schematic 2401 may comprise a plurality of functional modules including leads 2402 from electrodes in the reaction chamber solution, one or more output signal modulation modules 2403, one or more filters 2404, an analog-to-digital converter (ADC) 2405, and a plurality of other modules and components for performing potentiostatic measurement of the reaction chamber.

The leads 2402 from the electrochemical reaction chamber may connect to at least three electrodes including, but not limited to, the aforementioned working electrode, counter electrode, and reference electrode.

The output signal modulation module 2403 may perform a series of modulations on output signals from the leads 2402. This modulation may include amplification, frequency, or phase modulation, or other modulations.

Before being passed into the ADC 2405, the output signal from the leads 2402 may be filtered by a plurality of filters 2404 of various type to increase the signal-to-noise ratio.

A reference feedback loop 2406, if present, may modulate the value of the reference electrodes within the reaction chamber.

A variety of systems and methods, including software implemented methods can also be used in accordance with the devices and systems disclosed herein. For example, International Patent Publication No. 2014/008316 A2, previously incorporated by reference, provides illustrative methods, including software-implemented methods that can be used in accordance with this disclosure.

### EXAMPLE

Software is implemented to have a series of interfaces on a PMD 101. For example, the software includes a splash screen that is displayed while the PMD 101 checks electronics, system status, and/or network connectivity. An error may appear if any one of these checks returns a negative result. If the checks return positive results, a notification thereof may appear, and the operator may be prompted to enter credentials (e.g., username and password, barcode, QR code, biometric indicator, etc.). The PMD 101 may then display a main menu, which may (1) allow the operator to execute commands present on main menu, (2) inform the operator of time remaining before a quality control (QC) run is required, (3) allow the operator to customize where information is sent via an IP address or otherwise, (4) allow the operator to view results of previous tests performed, including which tests were run, when, by whom, on whom, lot number, etc.; and/or (5) allow the user to enter a quality-control mode. Quality-control mode may include options to (1) rerun the initial system check; (2) run positive control; (3) run negative control; and/or (4) view calibration and QC history. The operator may enter patient information, such as by scanning a barcode or QR code, or entering a unique patient identification code.

In some embodiments, a sample is collected from a patient, such as via a nasal swab. The sample is contacted with an electrode of the analyzer for testing. The analyzer and/or the software in the PMD 101 may identify the cartridge based upon a microcontroller with a device “signature” or a similar mechanism. The analyzer tests the cartridge to determine a property of the sample (e.g., concentration of an analyte, presence or absence of an analyte, etc.).

While the analyzer tests the cartridge, the PMD 101 may display a timer countdown showing the time remaining until results will be available. In some embodiments, the operator may choose to have the PMD 101 initiate an audible or visual an alarm when results are available.

The PMD 101 may display test results once the testing is complete. The test results may include a positive or negative result, a concentration, etc. The software may allow the operator to add comments or a flag (e.g., a flag indicating that further attention or review is needed) to be included with the results. Results may then be sent to a central lab, a hospital, another provider, and/or a patient. Results may be sent via a wireless network, a wired network, and/or a cellular network, etc.

What is claimed is:

1. A system for diagnostic testing comprising:
an analyzer comprising a first interface and a second interface, wherein the first interface is configured to be coupled to a portable multifunctional device and the second interface is configured to be coupled to a sample cartridge; and
a sample cartridge comprising a chemical entity bound to an electrode for electrochemical detection of a biological analyte, wherein the chemical entity is selected from the group consisting of peptides, thiolated carbon chains, nucleic acid constructs, aptamers, and oligonucleotides, wherein the sample cartridge is configured to receive an electrical signal transmitted from the portable multifunctional device through the analyzer to initiate a diagnostic test sequence.

2. The system of claim 1, wherein the analyzer is configured to be coupled to a portable multifunctional device selected from the group consisting of at least one of a portable computer, a tablet computer, and a mobile telephone.

3. The system of claim 1, wherein the sample cartridge is consumable.

4. The system of claim 1, wherein the analyzer is configured to be controlled by a user interface on the portable multifunctional device.

5. The system of claim 1, wherein the sample cartridge is configured to transmit a second electrical signal to the portable multifunctional device via the analyzer, the second electrical signal generated during the diagnostic test sequence.

6. The system of claim 5, wherein the portable multifunctional device is configured to receive the second electrical signal.

7. The system of claim 1, wherein the sample cartridge comprises at least one unique identifying code.

8. The system of claim 1, wherein the sample cartridge is configured to detect a biological analyte carried by at least one of a flocked swab, a capillary, and a loop.

9. The system of claim 1, wherein the electrode is configured to contact at least a portion of a test sample during the diagnostic test sequence.

10. The system of claim 1, wherein the analyzer is configured to be simultaneously coupled to a plurality of sample cartridges.

11. The system of claim 1, wherein the sample cartridge comprises a control electrode for calibrating the sample cartridge.

12. The system of claim 1, wherein the sample cartridge comprises a buffer.

13. A method of performing a diagnostic test, the method comprising:
connecting an analyzer to a portable multifunctional device;
connecting the analyzer to a sample cartridge, the sample cartridge comprising a chemical entity bound to an electrode for electrochemical detection of a biological analyte, wherein the chemical entity is selected from the group consisting of peptides, thiolated carbon chains, nucleic acid constructs, aptamers, and oligonucleotides;
disposing a test sample in contact with the electrode; and
instructing the portable multifunctional device to initiate a diagnostic test sequence within the analyzer to test for the biological analyte.

14. The method of claim 13, wherein connecting an analyzer to a portable multifunctional device comprises initiating a wireless connection between the analyzer and the portable multifunctional device.

15. The method of claim 13, wherein connecting an analyzer to a portable multifunctional device comprises disposing the portable multifunctional device in physical contact with the analyzer.

16. The method of claim 13, further comprising contacting a test sample with an electrode, wherein the electrode is in electrical contact with the analyzer.

17. The method of claim 13, further comprising transmitting test results from the analyzer to the portable multifunctional device.

18. The method of claim 17, further comprising transmitting the test results from the portable multifunctional device via a computer network.

19. The method of claim 13, further comprising binding the biological analyte to the electrode to determine a property of the test sample.

20. A system for diagnostic testing, the system comprising:
an analyzer comprising a first interface and a second interface, wherein the first interface is configured to be coupled to a computing device selected from the group consisting of a desktop computer, a portable computer, a tablet computer, and a mobile telephone, wherein the second interface is configured to be coupled to a sample cartridge; and
a sample cartridge comprising a buffer and at least one electrode configured for electrochemical detection of a biological analyte when a test sample is disposed in contact with the buffer wherein the sample cartridge is configured to receive an electrical signal transmitted through the analyzer from the computing device to initiate a diagnostic test sequence.
